(19) United States
(12) Patent Application Publication
(10) Pub. No.: US 2012/0194498 A1
(43) Pub. Date: Aug. 2, 2012

(54) BI-STABLE ACTIVE MATRIX DISPLAY APPARATUS AND METHOD FOR DRIVING DISPLAY PANEL THEREOF

(75) Inventors: Deng-Ke Yang, Kent, OH (US); Heng-Yin Chen, Hsinchu County (TW); Young-Cheol Yang, Kent, OH (US); Rafael S. Zola, Kent, OH (US); Chao-Chiun Liang, New Taipei City (TW); Chih-Jen Chen, Tainan City (TW)

(73) Assignees: KENT STATE UNIVERSITY, Kent, OH (US); INDUSTRIAL TECHNOLOGY RESEARCH INSTITUTE, Hsinchu (TW)

(21) Appl. No.: 13/183,444

(22) Filed: Jul. 15, 2011

(30) Foreign Application Priority Data
Feb. 1, 2011 (TW) 100103979

(51) Int. Cl. G09G 3/36; G06F 3/038

(52) U.S. Cl. 345/211; 345/90

(57) ABSTRACT

A bi-stable active matrix (AM) display apparatus and a method for driving a display panel thereof are provided. The bi-stable AM display apparatus includes a bi-stable AM display panel, a scan driver, a data driver and a controller. A frame period is divided into a resetting phase and a determining phase. The controller resets pixels on a plurality of scan lines of the bi-stable AM display panel to a homotropic state in the resetting phase through the scan driver and the data driver. The controller writes frame information into the pixels on the scan lines in the determining phase through the scan driver and the data driver.

### CROSS-REFERENCE TO RELATED APPLICATION

This application claims the priority benefit of Taiwan application serial no. 100103979, filed Feb. 1, 2011. The entirety of the above-mentioned patent application is hereby incorporated by reference herein and made a part of this specification.

### BACKGROUND

1. Field of the Disclosure

The disclosure relates to a display apparatus. Particularly, the disclosure relates to a bi-stable active matrix (AM) display apparatus and a method for driving a bi-stable AM display panel.

2. Description of Related Art

A conventional method for driving a cholesteric liquid crystal display (Ch-LCD) is to drive each pixel to a planar state (or a reflective state, a bright state), and then maintain the pixel to the bright state or drive the pixel to a focal conic state (or a non-reflective state, a dark state) according to updated frame information. However, such method requires a long time, which cannot satisfy a demand of dynamic video.

### SUMMARY OF THE DISCLOSURE

The disclosure is directed to a method for driving a bi-stable active matrix (AM) display panel. The method includes dividing a frame period into at least a resetting phase and a determining phase; resetting pixels on a plurality of scan lines of the bi-stable AM display panel to a homotropic state in the resetting phase; and writing updated frame information into the pixels on the scan lines in the determining phase.

The disclosure is directed to a bi-stable active matrix (AM) display apparatus including a bi-stable AM display panel, a scan driver, a data driver and a controller. The bi-stable AM display panel has a plurality of scan lines and a plurality of data lines. The scan driver is coupled to the scan lines. The data driver is coupled to the data lines. The controller is coupled to the scan driver and the data driver. During a resetting phase of a frame period, the controller resets pixels on the scan lines to a homotropic state through the scan driver and the data driver. During a determining phase of the frame period, the controller writes updated frame information into the pixels on the scan lines through the scan driver and the data driver.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification.

The drawings illustrate embodiments of the disclosure and, together with the description, serve to explain the principles of the disclosure.

FIG. 1 is a functional block schematic diagram of a bi-stable active matrix (AM) display apparatus according to an exemplary embodiment of the disclosure.

FIG. 2 is an ideal curve schematic diagram of a reflectivity-voltage curve of cholesteric liquid crystal (ChLC).

FIG. 3 is a schematic diagram illustrating signal timings of the display apparatus of FIG. 1.

FIGS. 4A-4D are signal timing diagrams of a pixel 111 of FIG. 1 according to the exemplary embodiment of FIG. 3.

FIG. 5 is a signal timing diagram of the display apparatus 100 of FIG. 1 according to an exemplary embodiment of the disclosure.

FIGS. 6A-6B are signal timing diagrams of the pixel 111 of FIG. 1 according to the exemplary embodiment of FIG. 5.

FIG. 6C is a signal timing diagram of the pixel 111 of FIG. 1 according to another exemplary embodiment of the disclosure.

FIG. 7 is a signal timing diagram of the display apparatus of FIG. 1 according to another exemplary embodiment of the disclosure.

FIG. 8 is a signal timing diagram of the display apparatus of FIG. 1 according to still another exemplary embodiment of the disclosure.

### DETAILED DESCRIPTION OF DISCLOSED EMBODIMENTS

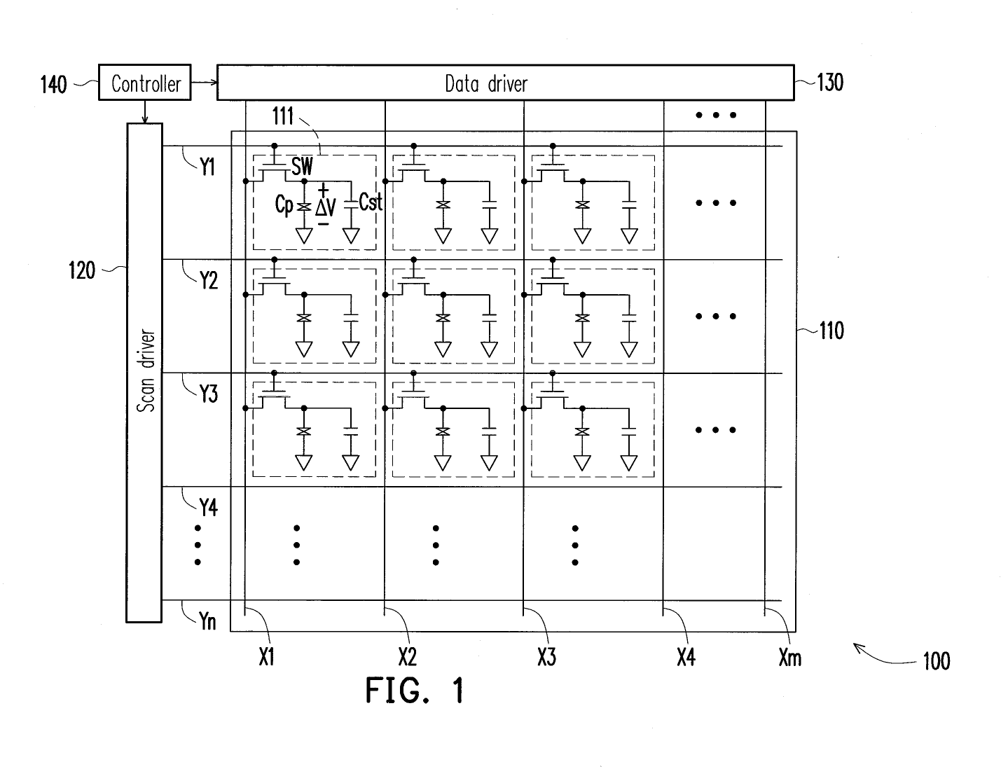

FIG. 1 is a functional block schematic diagram of a bi-stable active matrix (AM) display apparatus 100 according to an exemplary embodiment of the disclosure. The display apparatus 100 includes a bi-stable AM display panel 110, a scan driver 120, a data driver 130 and a controller 140. The bi-stable AM display panel 110 can be an AM cholesteric liquid crystal display (Ch-LCD) panel or other bi-stable display medium display panels. The bi-stable AM display panel 110 has a plurality of scan lines Y1, Y2, Y3, Y4, . . . , Yn and a plurality of data lines X1, X2, X3, X4, Xm. The scan driver 120 is coupled to the scan lines Y1-Yn. The data driver 130 is coupled to the data lines X1-Xm. The controller 140 is coupled to the scan driver 120 and the data driver 130.

A pixel is disposed at an intersection of each scan line and each data line, for example, a pixel 111 is disposed at an intersection of the scan line Y1 and the data line X1. Each pixel includes a switch device SW, a storage capacitor Cst and a pixel capacitor Cp, as that shown in FIG. 1. The switch device SW can be a thin film transistor (TFT) or other controlled switches. A first end of the switch device SW is coupled to the data line X1, and a control end of the switch device SW is coupled to the scan line Y1. First ends of the pixel capacitor Cp and the storage capacitor Cst are coupled to a second end of the switch device SW, and second ends of the pixel capacitor Cp and the storage capacitor Cst are respectively coupled to the same or different reference voltage. For example, in the present exemplary embodiment, the second end of the pixel capacitor Cp and the second end of the storage capacitor Cst are coupled to a common voltage Vcom. In other embodiments, the second end of the pixel capacitor Cp and the second end of the storage capacitor Cst are respectively coupled to different reference voltages, for example, the second end of the pixel capacitor Cp is coupled to the common voltage Vcom, and the second end of the storage capacitor Cst is coupled to a ground voltage.

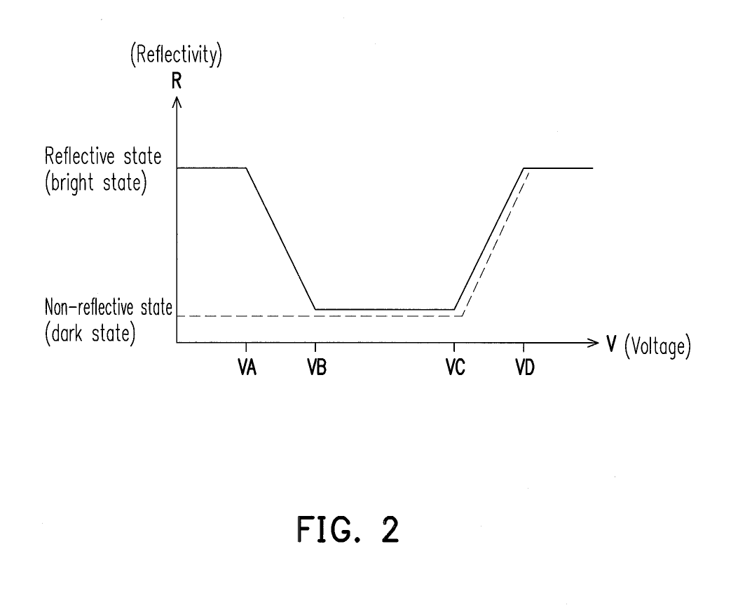

A bi-stable display medium, for example, cholesteric liquid crystal (ChLC) is disposed between two electrodes of the pixel capacitor Cp. Taking the ChLC as an example, FIG. 2 is an ideal curve schematic diagram of a reflectivity-voltage curve of the ChLC. A horizontal axis of FIG. 2 represents voltage amplitude (an absolute value) between the two electrodes of the pixel capacitor Cp, and a vertical axis represents light reflectivity of the bi-stable pixel (the pixel capacitor Cp). A solid line of FIG. 2 is a characteristic curve when an initial state of the liquid crystal molecules is a planar state (or a bright state), and a dot line is a characteristic curve when the initial state of the liquid crystal molecules is a focal conic state (or a dark state). When the initial state of the pixel is the bright state (referring to the solid line of FIG. 2), as the voltage amplitude between the electrodes is increased from VA to VB, the state of the pixel is changed from the bright state to the dark state. If the voltage amplitude between the electrodes is continually increased, as the voltage amplitude is increased from VC to VD, the state of the pixel is changed from a homotropic state to the bright state. When the initial state of the pixel is the dark state (referring to the dot line of FIG. 2), during the process of increasing the voltage amplitude between the electrodes, the state of the pixel is maintained to the dark state. If the voltage amplitude between the electrodes is continually increased, as the voltage amplitude is increased from VC to VD, the state of the pixel is changed from the homotropic state to the bright state.

The controller 140 stores and processes frame information. The controller 140 outputs the frame information to the data driver 130, and controls the data driver 130 to output the frame information to the bi-stable AM display panel 110 through the data lines X1-Xm. Meanwhile, the controller 140 controls the scan driver 120 to output a scan line to driver the switch device SW of each pixel (for example, the pixel 111) through the scan lines Y1-Yn.

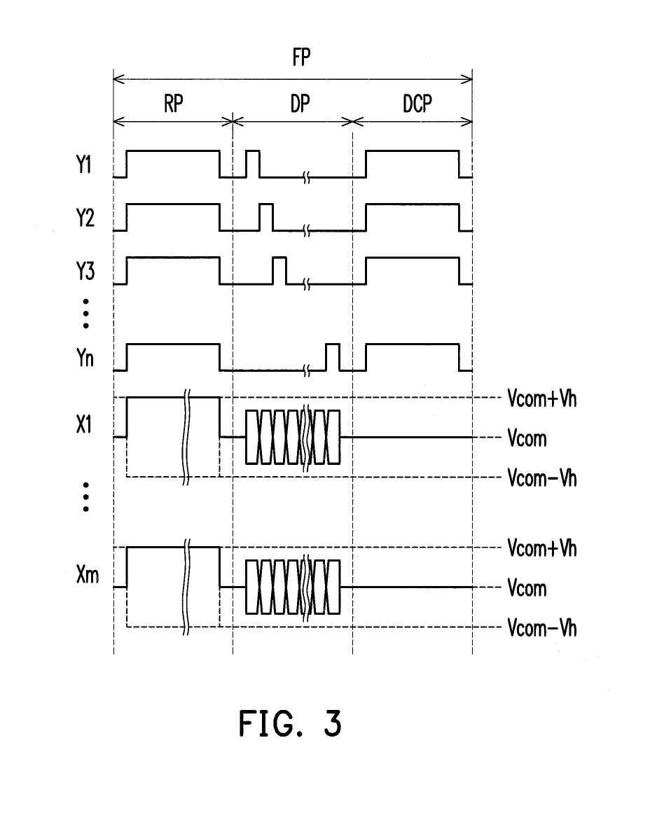

FIG. 3 is a schematic diagram illustrating signal timings of the display apparatus 100 of FIG. 1. In the present exemplary embodiment, a frame period FP is divided into a resetting phase RP, a determining phase DP and a discharge phase DCP. During the resetting phase RP, the controller 140 drives the scan lines Y 1-Yn through the scan driver 120 to simultaneously turn on the switch devices SW of the pixels on each of the scan lines Y1-Yn. When the switch devices SW of the pixels are turned on, the controller 140 outputs a resetting voltage Vcom+Vh or Vcom−Vh to the data lines X1-Xm through the data driver 130, so as to write the resetting voltage into the pixel capacitors Cp of all of the pixels.

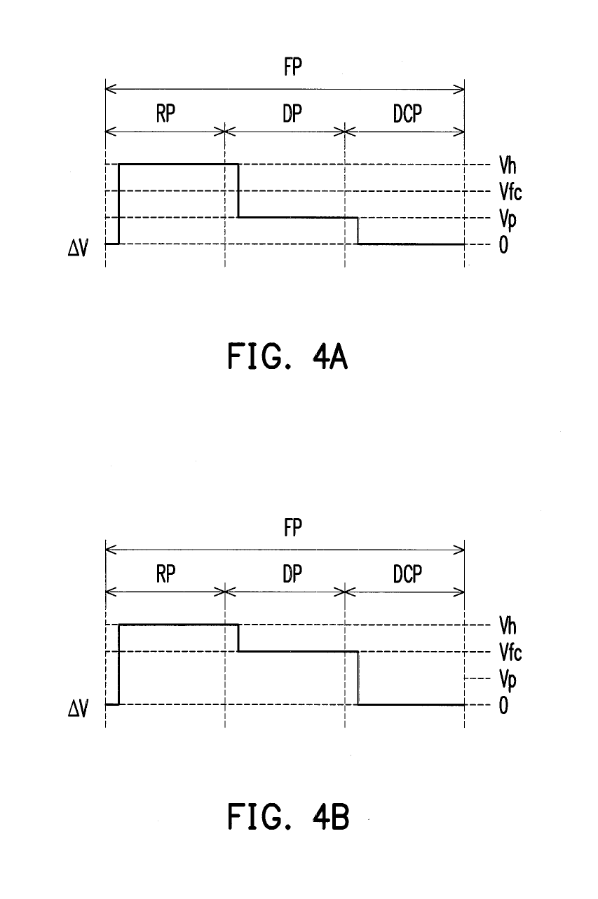

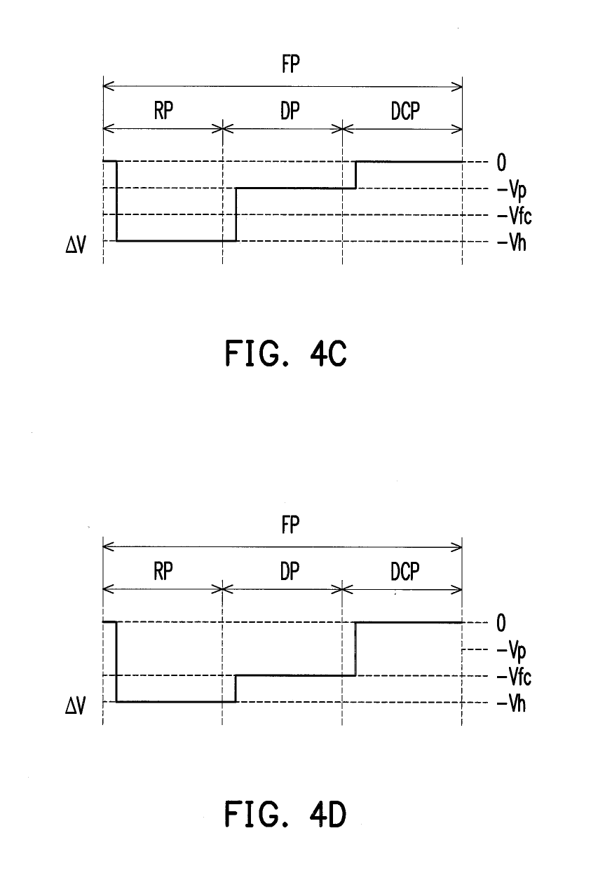

FIGS. 4A-4D are signal timing diagrams of the pixel 111 of FIG. 1 according to the exemplary embodiment of FIG. 3. If the data driver 130 outputs the resetting voltage Vcom+Vh with a positive polarity to the data line X1, during the resetting phase RP, a voltage difference ΔV of the pixel capacitor Cp of the pixel 111 is Vh, as that shown in FIG. 4A and FIG. 4B. If the data driver 130 outputs the resetting voltage Vcom−Vh with a negative polarity to the data line X1, during the resetting phase RP, the voltage difference ΔV of the pixel capacitor Cp of the pixel 111 is −Vh, as that shown in FIG. 4C and FIG. 4D. The voltage Vh may reset the pixel 111 to the homotropic state. Namely, during the resetting period RP of the frame period FP, the controller 140 resets all of the pixels on the scan lines Y1-Yn to the homotropic state through the scan driver 120 and the data driver 130.

The determining phase DP is entered after the resetting phase RP is ended. Referring to FIG. 3, during the determining phase DP, the controller 140 sequentially drives the scan lines Y1-Yn through the scan driver 120. In collaboration with the scan timing of the scan lines Y1-Yn, the controller 140 outputs the frame information to the data lines X1-Xm through the data driver 130 to write the updated frame information to the pixels on the scan lines Y1-Yn. If the pixel is to be set to the bright state, a bright state voltage Vcom+Vp or Vcom−Vp is applied to the pixel when the pixel is scanned during the determining phase DP. If the pixel is to be set to the dark state, a dark state voltage Vcom+Vfc or Vcom−Vfc is applied to the pixel when the pixel is scanned during the determining phase DP. The voltage Vp is smaller than or approximately equal to the voltage VA of FIG. 2, and the voltage Vfc is approximately between the voltage VB and the voltage VC of FIG. 2.

In case that the pixel 111 is driven by a signal with the positive polarity, if the pixel 111 is to be set to the bright state, the bright state voltage Vcom+Vp is applied to the pixel 111 when the pixel 111 is scanned during the determining phase DP (i.e. when the switch device SW of the pixel 111 is turned on). Therefore, the voltage difference ΔV of the pixel capacitor Cp of the pixel 111 is Vp, as that shown in FIG. 4A. If the pixel 111 is to be set to the dark state, the dark state voltage Vcom+Vfc is applied to the pixel 111 when the pixel 111 is scanned during the determining phase DP. Therefore, the voltage difference ΔV of the pixel capacitor Cp of the pixel 111 is Vfc, as that shown in FIG. 4B. The bright state voltage Vp is smaller than the dark state voltage Vfc, and the voltages Vp and Vfc are all smaller than the resetting voltage Vh.

In case that the the pixel 111 is driven by a signal with the negative polarity, if the pixel 111 is to be set to the bright state, the bright state voltage Vcom−Vp is applied to the pixel 111 when the pixel 111 is scanned during the determining phase DP. Therefore, the voltage difference ΔV of the pixel capacitor Cp of the pixel 111 is −Vp, as that shown in FIG. 4C. If the pixel 111 is to be set to the dark state, the dark state voltage Vcom−Vfc is applied to the pixel 111 when the pixel 111 is scanned during the determining phase DP. Therefore, the voltage difference ΔV of the pixel capacitor Cp of the pixel 111 is −Vfc, as that shown in FIG. 4D.

The discharge phase DCP is entered after the determining phase DP is ended.

Referring to FIG. 3, during the discharge phase DCP, the controller 140 controls the scan driver 120 to simultaneously drive all of the scan lines Y1-Yn. Meanwhile, the controller 140 controls the data driver 130 to output the common voltage Vcom to the data lines X1-Xm to discharge the pixel capacitors Cp of all of the pixels. As shown in FIGS. 4A-4D, the voltage difference ΔV of the pixel capacitor Cp of the pixel 111 is discharged to 0V during the discharge phase DCP. Since before the frame period FP is ended, all of the pixel capacitors Cp are discharged to 0V, when the pixels are reset during the resetting phase of a next frame period, damage of the switch device SW within the pixel due to impact of the resetting voltage can be avoided.

However, the discharge phase DCP may cause a slow frame refreshing rate. By ameliorating the bi-stable display medium, the bright state voltage Vp, the dark state voltage Vfc and the resetting voltage Vh can be reduced. Since the bright state voltage Vp, the dark state voltage Vfc and the resetting voltage Vh are reduced, damage of the switch device SW within the pixel caused by applying the resetting voltage can be avoided, so that the above discharge phase DCP can be omitted. In a following embodiment, the original functions are all achieved as the discharge phase is omitted.

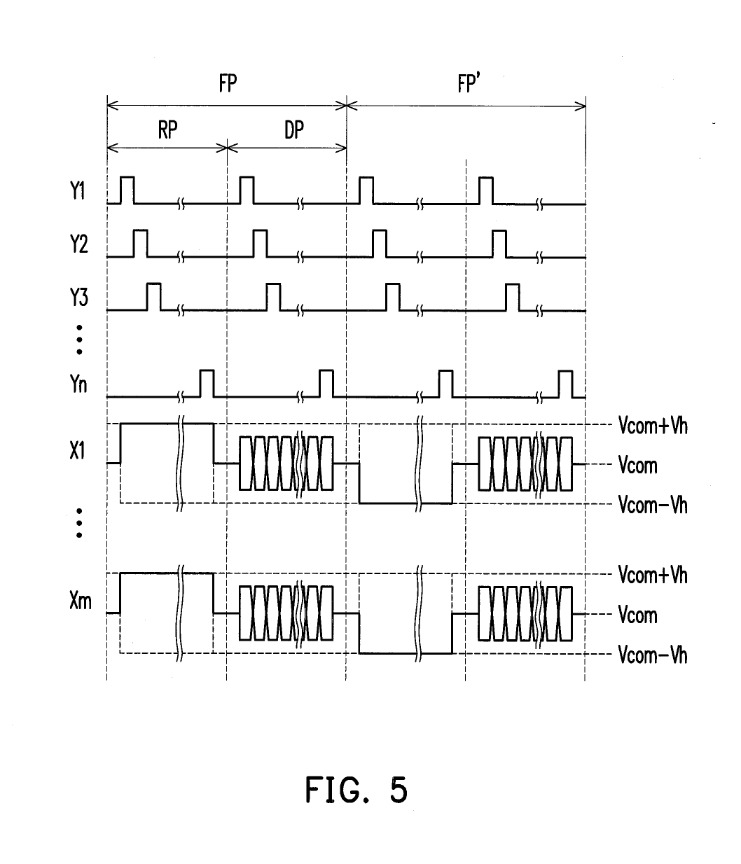

FIG. 5 is a signal timing diagram of the display apparatus 100 of FIG. 1 according to an exemplary embodiment of the disclosure. The exemplary embodiment of FIG. 5 is similar to that of FIG. 3, and a difference there between is that the discharge phase DCP of the frame period FP is omitted, and the driving method of the scan lines Y1-Yn during the resetting phase RP is different.

Referring to FIG. 5, the frame period FP is divided into the resetting phase RP and the determining phase DP. In the present exemplary embodiment, the frame period FP is only composed of the resetting phase RP and the determining phase DP. During the resetting phase RP, the controller 140 resets the pixels on the scan lines Y1-Yn of the bi-stable AM display panel 110 to the homotropic state through the scan driver 120 and the data driver 130. During the determining phase DP, the controller 140 writes updated frame information into the pixels on the scan lines Yl-Yn through the scan driver 120 and the data driver 130. Operation details of a next frame period FP′ are similar to that of the frame period FP, where a frame information polarity of the frame period FP′ is different to that of the frame period FP.

In detail, the controller 140 controls the scan driver 120 to sequentially scan the scan lines Y1-Yn according to a predetermined scan sequence during the determining phase DP. The scan sequence can be as that shown in FIG. 5 or other scan sequences. During a process of scanning the scan lines Y1-Yn in the determining phase DP, the controller 140 correspondingly writes the updated frame information into the pixels on the scan lines Y1-Yn through the data driver 130 and the data lines X1-Xm. During the resetting phase RP, the controller 140 controls the scan driver 120 to sequentially scan the scan lines Y1-Yn in a scan sequence the same to that of the determining phase DP, as that shown in FIG. 5. During a process of scanning the scan lines Y1-Yn in the resetting phase RP, the controller 140 correspondingly writes the resetting voltage Vcom+Vh or Vcom−Vh into the pixels on the scan lines Y1-Yn through the data driver 130 and the data lines X1-Xm. Since the scan sequence of the scan lines Y1-Yn during the resetting phase RP is the same to the scan sequence during the determining phase DP, the pixels on different scan lines may all have a same resetting time.

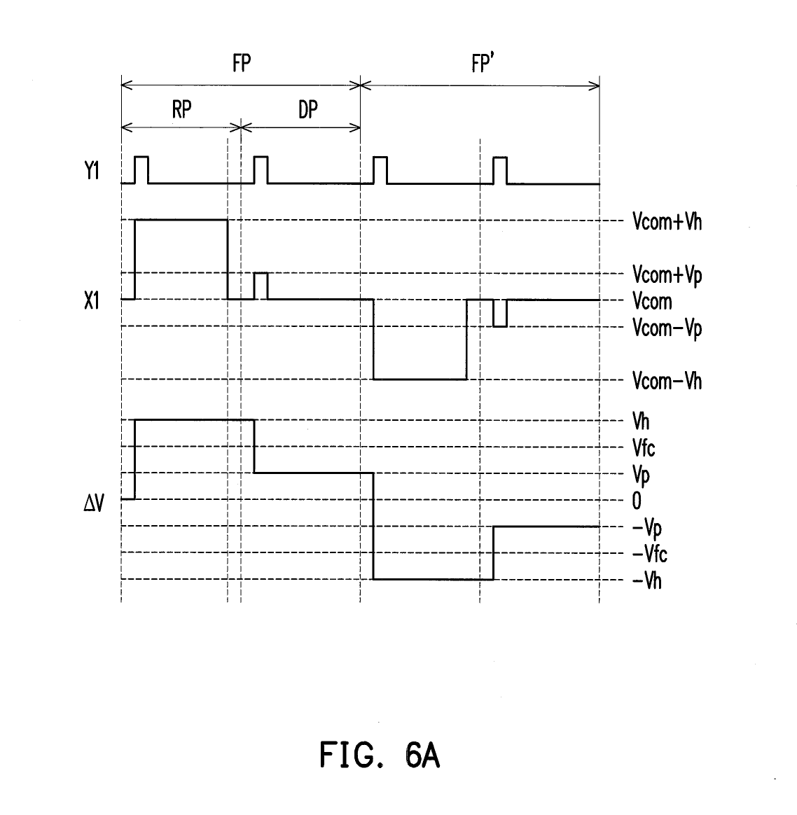

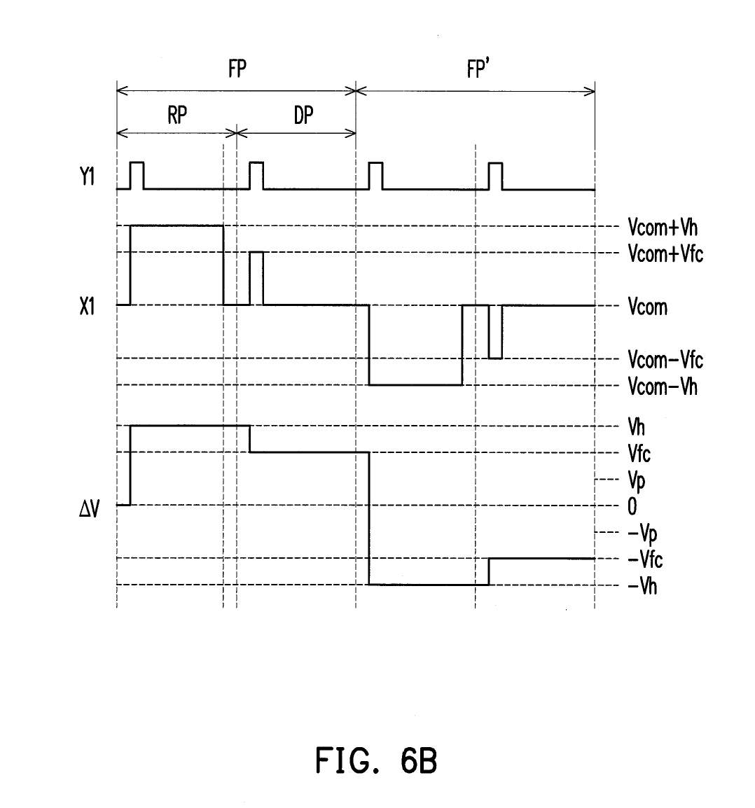

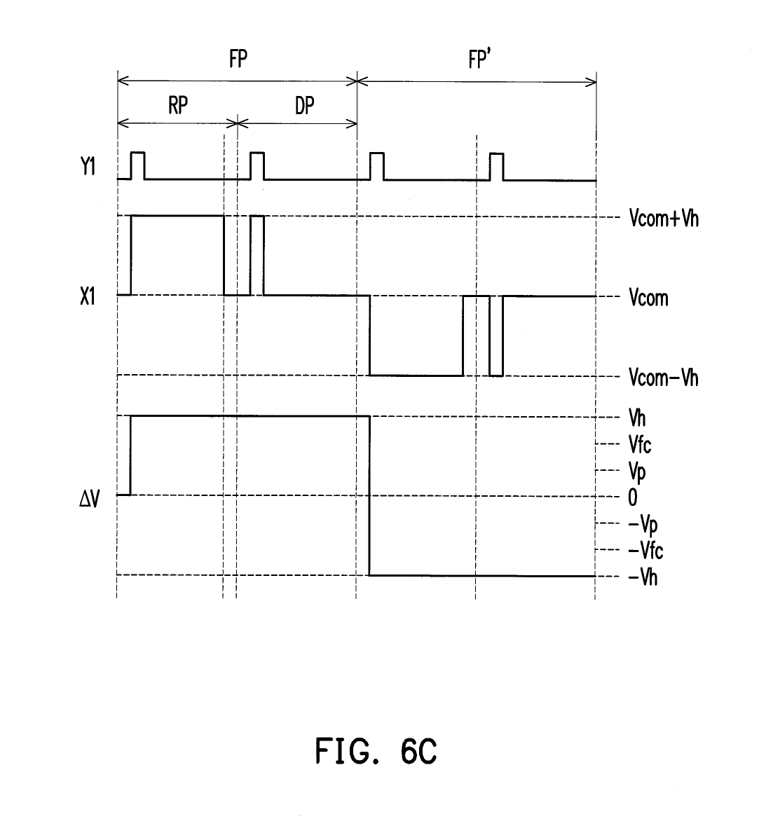

FIGS. 6A-6B are signal timing diagrams of the pixel 111 of FIG. 1 according to the exemplary embodiment of FIG. 5. During the resetting phase RP of the frame period FP, if the data driver 130 outputs the resetting voltage Vcom+Vh with a positive polarity to the data line X1, when the scan line Y1 is driven, the pixel capacitor Cp of the pixel 111 is charged by the resetting voltage Vcom+Vh. Therefore, after the scan line Y1 is driven, the voltage difference ΔV of the pixel capacitor Cp of the pixel 111 is Vh, as that shown in FIG. 6A and FIG. 6B. Deduced by analogy, during the next frame period FP′, if the data driver 130 outputs the resetting voltage Vcom—Vh with a negative polarity to the data line X1, after the scan line Y1 is driven, the voltage difference ΔV of the pixel capacitor Cp of the pixel 111 is −Vh, as that shown in FIG. 6A and FIG. 6B. The voltage Vh may reset the pixel 111 to the homotropic state. Namely, during the resetting period RP of the frame period FP, the controller 140 resets all of the pixels on the scan lines Y1-Yn to the homotropic state through the scan driver 120 and the data driver 130.

The determining phase DP is entered after the resetting phase RP is ended. If the pixel 111 is to be set to the bright state, when the pixel 111 is scanned during the determining phase DP (i.e. when the switch device SW of the pixel 111 is turned on), the controller 140 applies the bright state voltage Vcom+Vp with the positive polarity to the pixel 111 through the data driver 130 and the data line X1. Therefore, the voltage difference ΔV of the pixel capacitor Cp of the pixel 111 is Vp, as that shown in FIG. 6A. Deduced by analogy, during the next frame period FP′, if the pixel 111 is to be set to the bright state, when the pixel 111 is scanned during the determining phase DP, the controller 140 applies the bright state voltage Vcom−Vp with the negative polarity to the pixel 111 through the data driver 130 and the data line X1. Therefore, after the scan line Y1 is driven, the voltage difference ΔV of the pixel capacitor Cp of the pixel 111 is −Vp.

Referring to FIG. 6B, if the pixel 111 is to be set to the dark state, when the pixel 111 is scanned during the determining phase DP, the controller 140 applies the dark state voltage Vcom+Vfc with the positive polarity to the pixel 111 through the data driver 130 and the data line X1. Therefore, the voltage difference ΔV of the pixel capacitor Cp of the pixel 111 is Vfc. Deduced by analogy, during the next frame period FP′, if the pixel 111 is to be set to the dark state, when the pixel 111 is scanned during the determining phase DP, the controller 140 applies the dark state voltage Vcom—Vfc with the negative polarity to the pixel 111 through the data driver 130 and the data line X1. Therefore, after the scan line Y1 is driven, the voltage difference ΔV of the pixel capacitor Cp of the pixel 111 is −Vfc, as that shown in FIG. 6B.

By ameliorating and selecting the bi-stable display medium (for example, the ChLC) or by increasing a driving frequency of the data lines X1-Xm, the bright state voltage Vp, the dark state voltage Vfc and the resetting voltage Vh can be reduced. Since the bright state voltage Vp, the dark state voltage Vfc and the resetting voltage Vh are reduced, damage of the switch device SW within the pixel caused by applying the resetting voltage can be avoided. Compared to the embodiment of FIG. 3 and FIGS. 4A-4D, the discharging step of the discharge phase DCP is omitted in the embodiment of FIG. 5 and FIGS. 6A-6B, though the original functions are still achieved. Since the discharging step is omitted, the frame refreshing rate is accelerated.

In other embodiments, if the driving polarity of the frame period FP is the same to that of the next frame period FP′, for example, in the frame period FP′ shown in FIG. 6B, the data driver 130 changes to output the resetting voltage Vcom+Vh with the positive polarity and the dark state voltage Vcom+Vfc with the positive polarity to the data line X1, during the resetting phase RP of the frame period FP′, it is only required to pull up the voltage difference ΔV of the pixel capacitor Cp from Vfc to Vh. In the embodiment of FIG. 3 and FIGS. 4A-4D, during the resetting phase, the voltage difference ΔV of the pixel capacitor Cp is required to be pulled up from 0V to Vh. Therefore, in the present exemplary embodiment, unexpected effect (for example, a power saving effect) can be achieved by omitting the discharging step.

FIG. 6C is a signal timing diagram of the pixel 111 of FIG. 1 according to another exemplary embodiment of the disclosure. The present exemplary embodiment is similar to that of FIG. 5 and FIGS. 6A-6B, and a difference there between is that in the present exemplary embodiment, the resetting voltage Vh is used to replace the dark state voltage Vfc to obtain relatively low reflectivity. Referring to FIG. 6C, if the pixel 111 is to be set to the dark state, the resetting voltage Vcom+Vh with the positive polarity is applied to the pixel 111 when the pixel 111 is scanned during the determining phase DP (i.e. when the switch device SW of the pixel 111 is turned on). Therefore, the voltage difference ΔV of the pixel capacitor Cp of the pixel 111 is still maintained to the same voltage Vh as that in the resetting phase RP, and the pixel 111 is maintained to the homotropic state during both of the resetting phase RP and the determining phase DP. Therefore, if the pixel 111 is in the dark state, the data driver 130 of the present exemplary embodiment hardly changes the voltage difference ΔV of the pixel capacitor Cp during the determining phase DP. Therefore, in the present exemplary embodiment, unexpected effect (for example, a power saving effect) can be achieved by replacing the dark state voltage Vfc with the resetting voltage Vh.

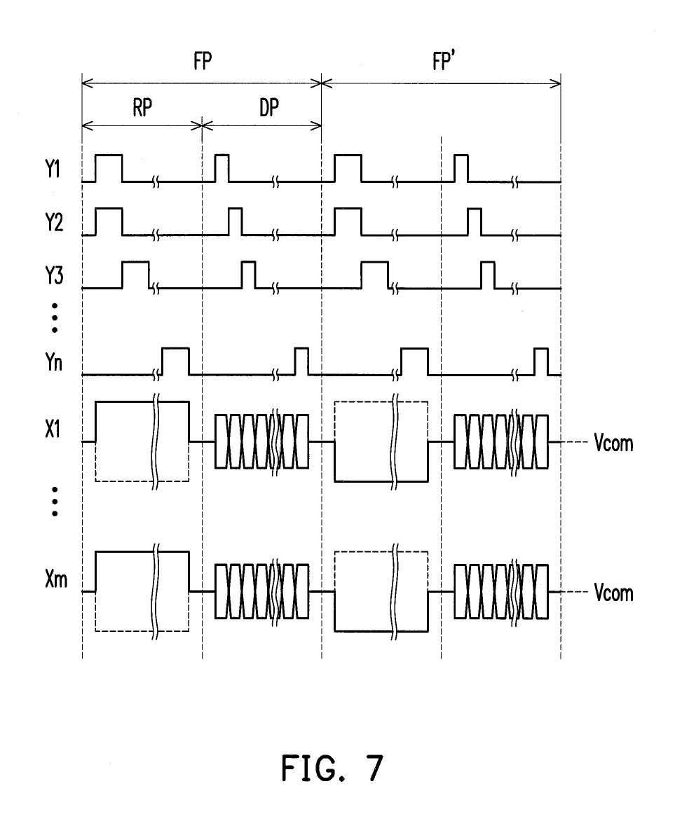

FIG. 7 is a signal timing diagram of the display apparatus 100 of FIG. 1 according to another exemplary embodiment of the disclosure. The exemplary embodiment of FIG. 7 is similar to that of FIG. 5 and FIGS. 6A-6C, and a difference there between is that in the present exemplary embodiment, the pixels of a plurality of scan lines are simultaneously reset during the resetting phase RP. The scan lines Y1-Yn are grouped into a plurality of groups, and each scan line group has two or more scan lines. For example, referring to FIG. 1 and FIG. 7, two adjacent scan lines Y1 and Y2 are belonged to a first scan line group, the scan line Y3 and the scan line Y4 are belonged to a second scan line group, and the others are deduced by analogy. During a first resetting sub phase of the resetting phase RP, the controller 140 resets pixels on the first scan line group to the homotropic state through the scan driver 120 and the data driver 130. During a second resetting sub phase of the resetting phase RP, the controller 140 resets pixels on the second scan line group to the homotropic state through the scan driver 120 and the data driver 130. The others are deduced by analogy.

In other embodiments, more scan lines can be grouped into one scan line group. For example, the adjacent four scan lines Y1, Y2, Y3 and Y4 are belonged to a same scan line group, and the others are deduced by analogy. In the present exemplary embodiment, since each time pixels on two or more scan lines are reset, time of the resetting phase RP can be greatly reduced. Moreover, since the scan sequence of the scan lines Y1-Yn in the resetting phase RP is approximately the same to the scan sequence of the determining phase DP, the pixels on different scan lines have similar resetting time.

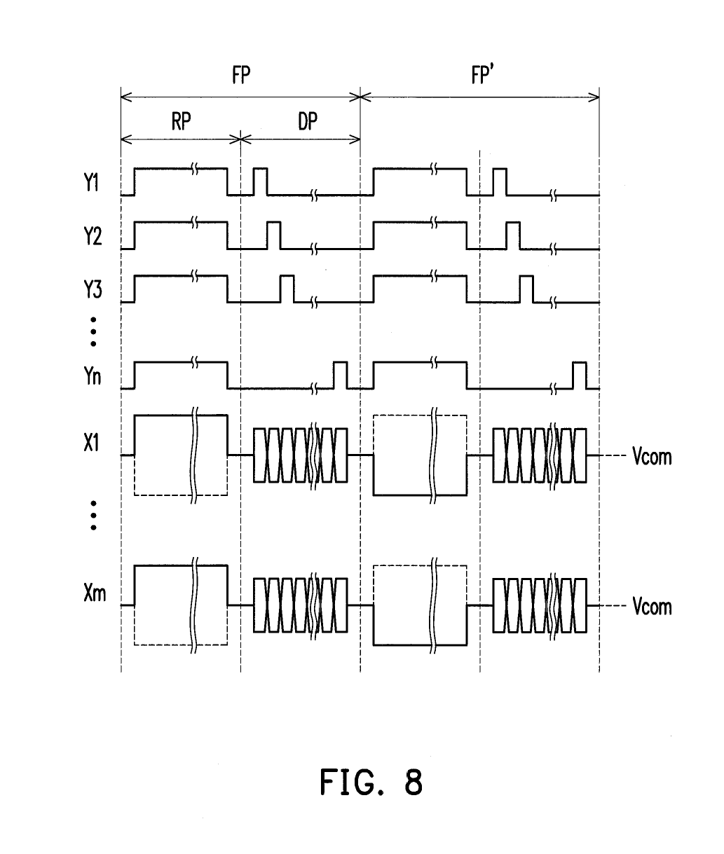

FIG. 8 is a signal, timing diagram of the display apparatus 100 of FIG. 1 according to still another exemplary embodiment of the disclosure. The exemplary embodiment of FIG. 8 is similar to that of FIG. 5 and FIGS. 6A-6C, and a difference there between is that in the present exemplary embodiment, the controller 140 simultaneously resets pixels of all of the scan lines Y1-Yn to the homotropic state during the resetting phase RP. In the present exemplary embodiment, since each time the pixels of all of the scan lines Y1-Yn are reset, time of the resetting phase RP can be greatly reduced.

The driving method of the disclosure may accelerate a frame refreshing rate of the bi-stable AM display panel.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for driving a bi-stable active matrix (AM) display panel, comprising:
dividing a frame period into at least a resetting phase and a determining phase;
resetting pixels on a plurality of scan lines of the bi-stable AM display panel to a homotropic state in the resetting phase; and
writing updated frame information into the pixels on the scan lines in the determining phase.

2. The method for driving the bi-stable AM display panel as claimed in claim 1, wherein the frame period is composed of the resetting phase and the determining phase.

3. The method for driving the bi-stable AM display panel as claimed in claim 1, wherein the pixels on the scan lines are simultaneously reset to the homotropic state in the resetting phase.

4. The method for driving the bi-stable AM display panel as claimed in claim 1, comprising:
grouping the scan lines;
resetting pixels of a first scan line group of the scan lines to the homotropic state in a first resetting sub phase of the resetting phase; and
resetting pixels of a second scan line group of the scan lines to the homotropic state in a second resetting sub phase of the resetting phase.

5. The method for driving the bi-stable AM display panel as claimed in claim 4, wherein the first scan line group comprises at least two scan lines.

6. The method for driving the bi-stable AM display panel as claimed in claim 1, wherein the step of writing the updated frame information into the pixels on the scan lines comprises:
sequentially scanning the scan lines according to a scan sequence in the determining phase; and
correspondingly writing the updated frame information into the pixels on the scan lines during a process of scanning the scan lines in the determining phase.

7. The method for driving the bi-stable AM display panel as claimed in claim 1, wherein the step of resetting the pixels on the scan lines to the homotropic state comprises:
sequentially scanning the scan lines according to a scan sequence in the resetting phase; and
correspondingly writing a resetting voltage into the pixels on the scan lines during a process of scanning the scan lines in the resetting phase.

8. The method for driving the bi-stable AM display panel as claimed in claim 6, wherein the step of writing the updated frame information into the pixels on the scan lines comprises:
if a pixel is to be set to a bright state, applying a bright state voltage to the pixel when the pixel is scanned during the determining phase; and
if the pixel is to be set to a dark state, applying a dark state voltage to the pixel when the pixel is scanned during the determining phase, wherein the bright state voltage is smaller than the dark state voltage.

9. The method for driving the bi-stable AM display panel as claimed in claim 6, wherein the step of writing the updated frame information into the pixels on the scan lines comprises:
if a pixel is to be set to a bright state, applying a bright state voltage to the pixel when the pixel is scanned during the determining phase; and
if the pixel is to be set to a dark state, applying a resetting voltage to the pixel when the pixel is scanned during the determining phase, so as to maintain the pixel to the homotropic state, wherein the bright state voltage is smaller than the resetting voltage.

10. The method for driving the bi-stable AM display panel as claimed in claim 1, wherein the bi-stable AM display panel is an AM cholesteric liquid crystal display panel.

11. A bi-stable active matrix (AM) display apparatus, comprising:
a bi-stable AM display panel, having a plurality of scan lines and a plurality of data lines;
a scan driver, coupled to the scan lines;
a data driver, coupled to the data lines; and
a controller, coupled to the scan driver and the data driver, wherein the controller resets pixels on the scan lines to a homotropic state through the scan driver and the data driver during a resetting phase of a frame period, and the controller writes updated frame information into the pixels on the scan lines through the scan driver and the data driver during a determining phase of the frame period.

12. The bi-stable AM display apparatus as claimed in claim 11, wherein the frame period is composed of the resetting phase and the determining phase.

13. The bi-stable AM display apparatus as claimed in claim 11, wherein the pixels on the scan lines are simultaneously reset to the homotropic state in the resetting phase.

14. The bi-stable AM display apparatus as claimed in claim 11, wherein the controller resets pixels of a first scan line group of the scan lines to the homotropic state through the scan driver and the data driver in a first resetting sub phase of the resetting phase, and the controller resets pixels of a second scan line group of the scan lines to the homotropic state through the scan driver and the data driver in a second resetting sub phase of the resetting phase.

15. The bi-stable AM display apparatus as claimed in claim 14, wherein the first scan line group comprises at least two scan lines.

16. The bi-stable AM display apparatus as claimed in claim 11, wherein the controller controls the scan driver to sequentially scan the scan lines according to a scan sequence in the determining phase, and the controller controls the data driver to correspondingly write the updated frame information into the pixels on the scan lines during a process of scanning the scan lines in the determining phase.

17. The bi-stable AM display apparatus as claimed in claim 16, wherein the controller controls the scan driver to sequentially scan the scan lines according to the scan sequence in the resetting phase, and the controller controls the data driver to correspondingly write a resetting voltage into the pixels on the scan lines during the process of scanning the scan lines in the resetting phase.

18. The bi-stable AM display apparatus as claimed in claim 16, wherein if a pixel of the bi-stable AM display panel is to be set to a bright state, the controller applies a bright state voltage to the pixel through the data driver when the pixel is scanned during the determining phase, and if the pixel is to be set to a dark state, the controller applies a dark state voltage greater than the bright state voltage to the pixel through the data driver when the pixel is scanned during the determining phase.

19. The bi-stable AM display apparatus as claimed in claim 16, wherein if a pixel of the bi-stable AM display panel is to be set to a bright state, the controller applies a bright state voltage to the pixel through the data driver when the pixel is scanned during the determining phase, and if the pixel is to be set to a dark state, the controller applies a resetting voltage greater than the bright state voltage to the pixel through the data driver, so as to maintain the pixel to the homotropic state when the pixel is scanned during the determining phase.

20. The bi-stable AM display apparatus as claimed in claim 11, wherein the bi-stable AM display panel is an AM cholesteric liquid crystal display panel.
